(19) United States
(12) Patent Application Publication
(10) Pub. No.: US 2010/0125768 A1
(43) Pub. Date: May 20, 2010

(54) ERROR RESILIENCE IN VIDEO COMMUNICATION BY RETRANSMISSION OF PACKETS OF DESIGNATED REFERENCE FRAMES

(75) Inventors: J. William Mauchly, Berwyn, PA (US); Joseph T. Friel, Ardmore, PA (US); Dihong Tian, San Jose, CA (US)

Correspondence Address: EDELL, SHAPIRO & FINNAN, LLC, 1901 RESEARCH BOULEVARD, SUITE 400, ROCKVILLE, MD, 20850, US

(73) Assignee: CISCO TECHNOLOGY, INC., San Jose, CA (US)

(21) Appl. No.: 12/272,331

(22) Filed: Nov. 17, 2008

(51) Int. Cl. H04L 1/18; G06F 11/14

(52) U.S. Cl. 714/749; 714/E11.113

(57) ABSTRACT

Techniques are provided for video communication between multiple devices. Each of a plurality of video packets is designated as being part of a required reference frame that is subsequently to be used for a repair process. A stream of video packets that includes the packets for the required reference frame is transmitted from a source device over a communication medium for reception by a plurality of destination devices. A determination is made that at least one of the plurality of destination devices did not receive at least one packet of the required reference frame, and the at least one packet is retransmitted the at least one of the plurality of destination devices. When the retransmitted packet is received at the at least one destination device, it is decoded and stored without using it for generating a picture for display at the time that the at least one packet is received.

### TECHNICAL FIELD

The present disclosure relates to video communication systems and techniques.

### BACKGROUND

Real-time video is sensitive to latency. As a result, lost video packets in a video stream are usually not retransmitted because the decoder at the destination device cannot use them to correct for the lost packet when the retransmitted video packet eventually arrives. A packet is normally only useful to reconstruct a “current” video frame for display of a picture.

In some cases, it is unavoidable but to use a network over which the video streams are transmitted that has a relatively high error rate. At a certain level of packet loss, the probability is very low that the delivery of a frame is completely error free to all the destination devices. It is nevertheless desirable to guarantee that a certain reference frame is received and decoded without error by all intended destination devices. Error resilience of a video decoding process can be improved by decoding a late packet, if that packet can be used to repair an error in a frame that will be used as a reference frame in the future, that is, for display of a video frame yet to be displayed with respect to the current playout time.

### BRIEF DESCRIPTION OF THE DRAWINGS

FIG. 1 is a block diagram of a video distribution system configured to achieve improved error resilience by retransmission of packets of designated reference frames between endpoint devices.

FIG. 2 is a diagram of a device configured to perform transmit-side and receive-side processes associated with communication of packets of required reference frames.

FIG. 3 is a diagram of an intermediate multipoint control unit configured to serve as a relay point for packets associated with required reference frames transmitted from a source device to a plurality of destination devices.

FIG. 4 is a ladder diagram depicting the overall retransmission process between a source device and a destination device.

FIG. 5 is an example of a flow chart for a transmit-side control process performed in an endpoint device.

FIG. 6 is an example of a flow chart for a multipoint control process performed in the multipoint control unit.

FIG. 7 is an example of a flow chart for a receive-side control process performed in an endpoint device.

FIG. 8 is a timing diagram showing an example of how packets of a required reference frame may be transmitted in a stream of video packets.

FIG. 9 is a timing diagram showing an example of how a packet of a required reference frame may be retransmitted to a destination endpoint device.

### DESCRIPTION OF EXAMPLE EMBODIMENTS

Overview

Techniques are provided for video communication between multiple devices. Each of a plurality of video packets is designated as being part of a required reference frame that is subsequently to be used for a repair process. A stream of video packets that includes the packets for the required reference frame is transmitted from a source device over a communication medium for reception by a plurality of destination devices. A determination is made that at least one of the plurality of destination devices did not receive at least one packet of the required reference frame, and the at least one packet is retransmitted to the at least one of the plurality of destination devices. When the retransmitted packet is received at the at least one destination device, it is decoded and stored without using it for generating a picture for display at the time that the at least one packet is received.

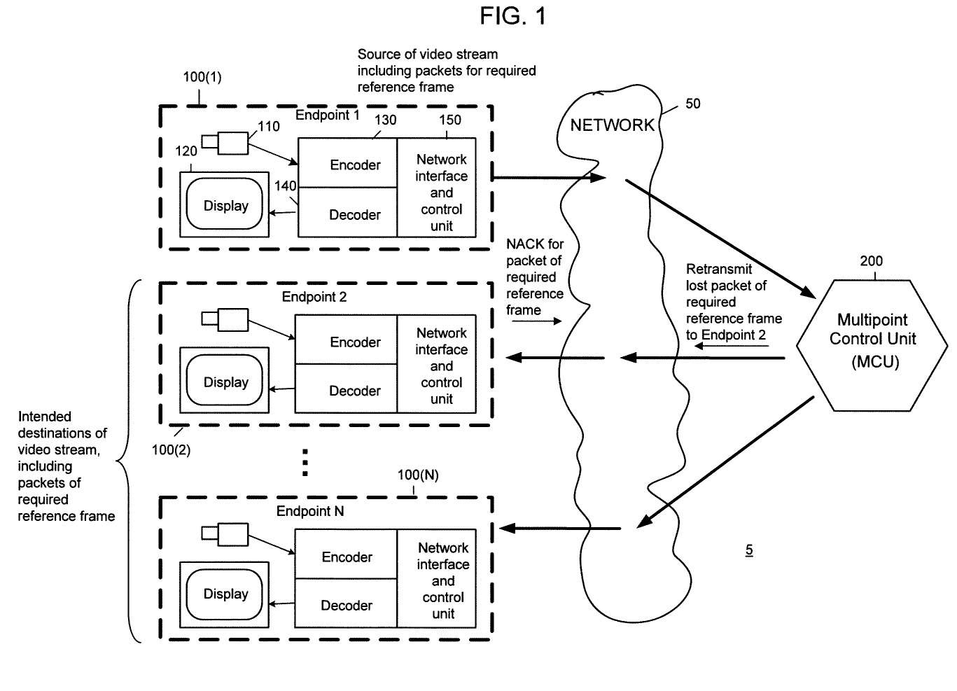

Referring first to FIG. 1, a video distribution system 5 is shown that is configured to achieve improved error resilience by retransmission of packets of designated reference frames between endpoint devices. The system 5 may be used to conduct video conferences between multiple endpoints, where the video streams transmitted between the endpoints are high-fidelity or high-quality video, thereby simulating an in-person meeting. In this regard, the system 10 is also referred to as a “telepresence” system.

The system 5 comprises a plurality of endpoint devices 100(1), 100(2), . . . , 100(N) each of which can simultaneously serve as both a source and a destination of a video stream (containing video and audio information). Each endpoint device, generically referred to by reference numeral 100(i), comprises at least one video camera 110, at least one display 120, an encoder 130, a decoder 140 and a network interface and control unit 150. The video camera 110 captures video and supplies video signals to the encoder 130. The encoder 130 encodes the video signals into packets for further processing by the network interface and control unit 150 that transmits the packets to one or more other endpoint devices. Conversely, the network interface and control unit 150 receives packets sent from another endpoint device and supplies them to the decoder 140. The decoder 140 decodes the packets into a format for display of picture information on the display 120. Audio is also captured by one or more microphones and encoded into the stream of packets passed between endpoint devices.

A video conference may be established between any two or more endpoint devices via a network 50. In particular, when there are more than two endpoint devices involved in a video conference, it is advantageous to have a third device that manages the distribution of information to all of the intended destination endpoint devices. To this end, a multipoint control unit (MCU) 200 is provided that also connects to the network 50 and forwards packets of information (video packets) from one endpoint device, referred to as a source device, to each of the other endpoint devices involved in the video conference, referred to herein as destination devices.

The endpoint devices and MCU 200 are configured to perform a retransmission process for packets that are part of a certain type of video frame, called a reference frame, and more particularly, part of a certain type of reference frame, called a required or “must-have” reference frame. When an endpoint device is acting as a source for a video stream, the endpoint device generates and includes in the video stream packets associated with a required reference frame. For example, the endpoint device 100(1) is acting as a source device with respect to a video stream that is being transmitted to a plurality of intended destination devices 100(2)-100(N) as part of a video conference. The endpoint device 100(1) designates, labels or marks packets (e.g., in an appropriate header or other field) that are part of a required reference frame packets to indicate that they are part of a required reference frame. Normally, when a device successfully receives a packet, it transmits an acknowledgement (ACK) message for that packet. When an intended destination device, such as device 100(2) in FIG. 1, transmits a non-acknowledgement (NACK) message for a required reference frame packet, the MCU retransmits the lost or missing packet to destination device 100(2). Further details and advantages of this scheme are described hereinafter.

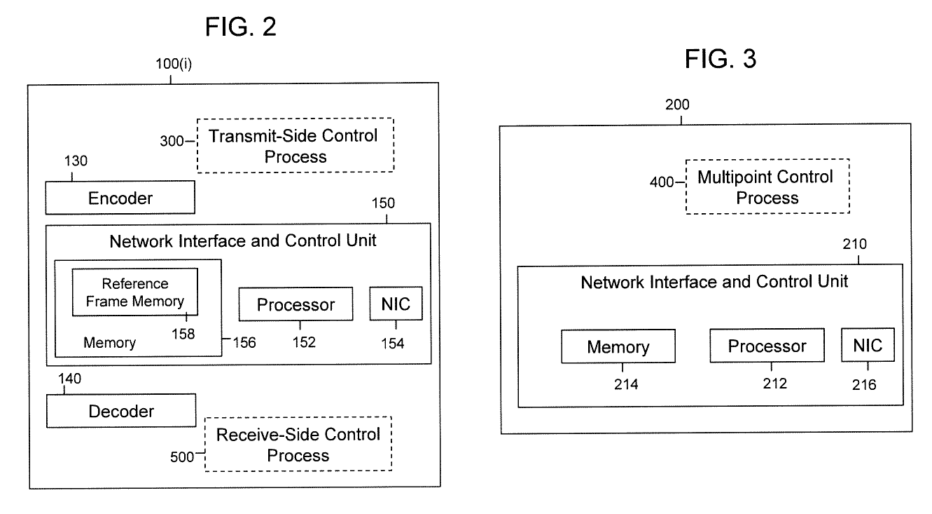

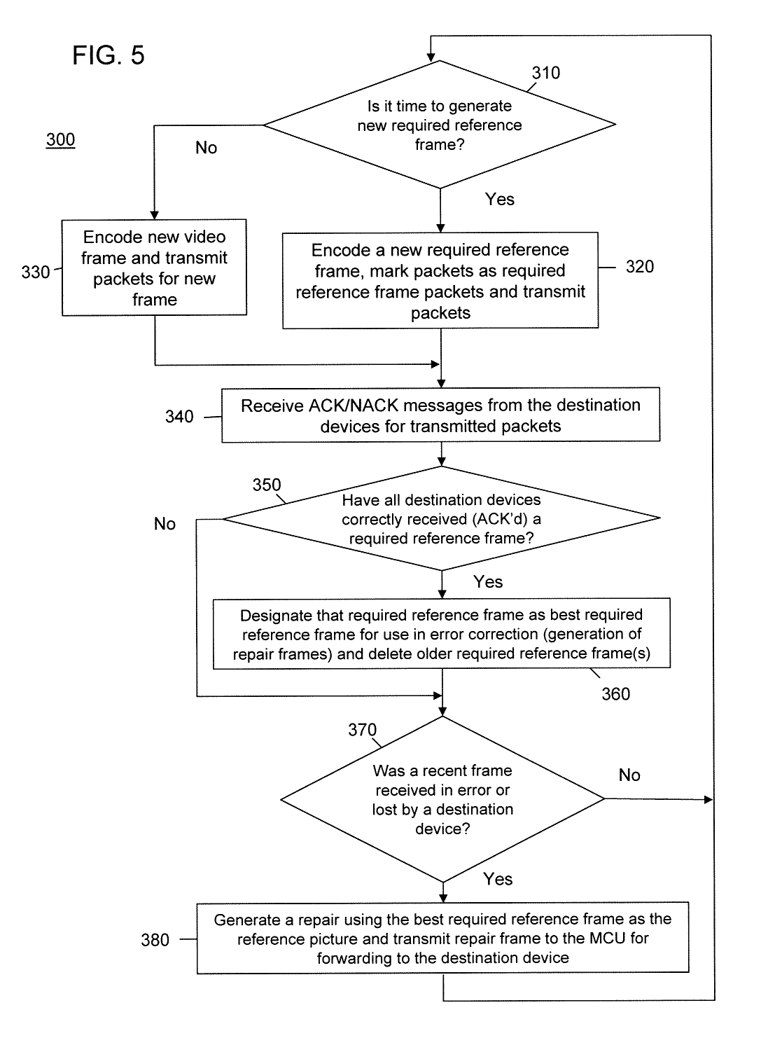

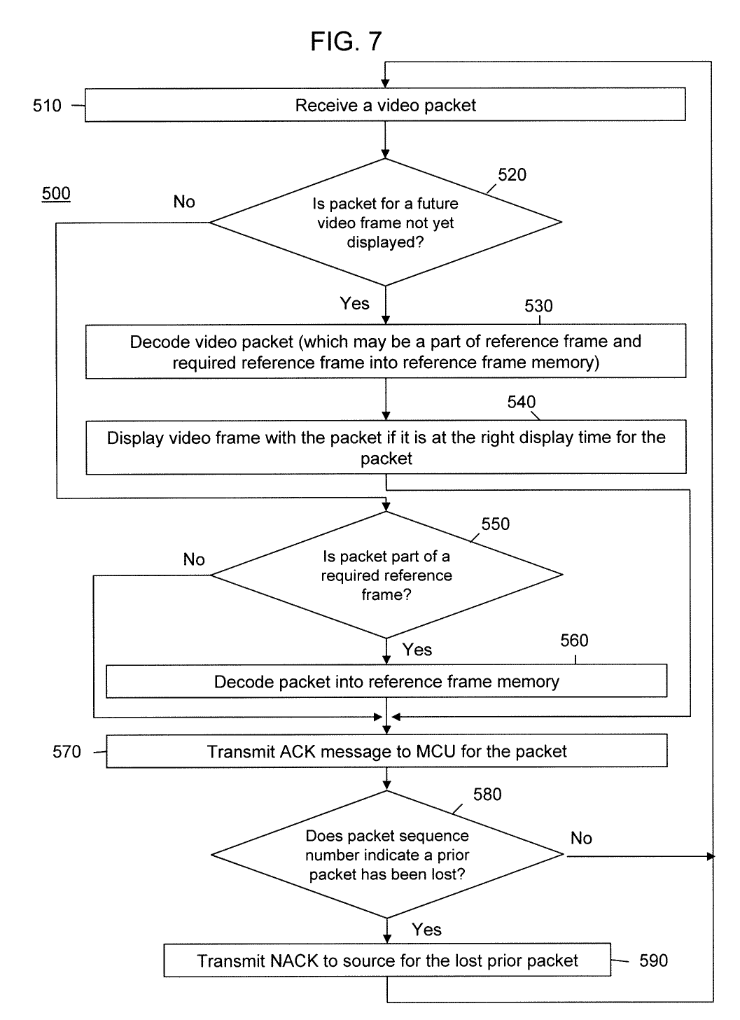

Turning now to FIG. 2, a more detailed block diagram of an endpoint device 100(i) is described. FIG. 2 shows the encoder 130, decoder 140 and network interface and control unit 150 of an endpoint device 100(i). In particular, the network interface and control unit 150 comprises a processor 152, a network interface card (NIC) or adapter 154 and a memory 156. The processor 152 performs several control processes according to instructions stored in the memory 156, including instructions for a transmit-side control process 300 and instructions for a receive-side control process 500. Video packets that are processed for transmission or that are received for decoding and display are stored in the memory 156. The NIC 154 coordinates communication of data to and from the network 50 according to the rules associated with the network transport mechanism of the network 50. There is a section in the memory 156, called a reference frame storage 158, allocated for storing packets for one or more reference frames. The processor 152 cooperates with the encoder 130 when executing the transmit-side control process 300 to send packets from the endpoint device 100(i) to other endpoint devices. Similarly, the processor 152 cooperates with the decoder 140 when executing the receive-side control process 500 to process packets received from other endpoint devices. The transmit-side control process 300 is described hereinafter in conjunction with FIG. 5 and the receive-side control process 500 is described hereinafter in conjunction with FIG. 7.

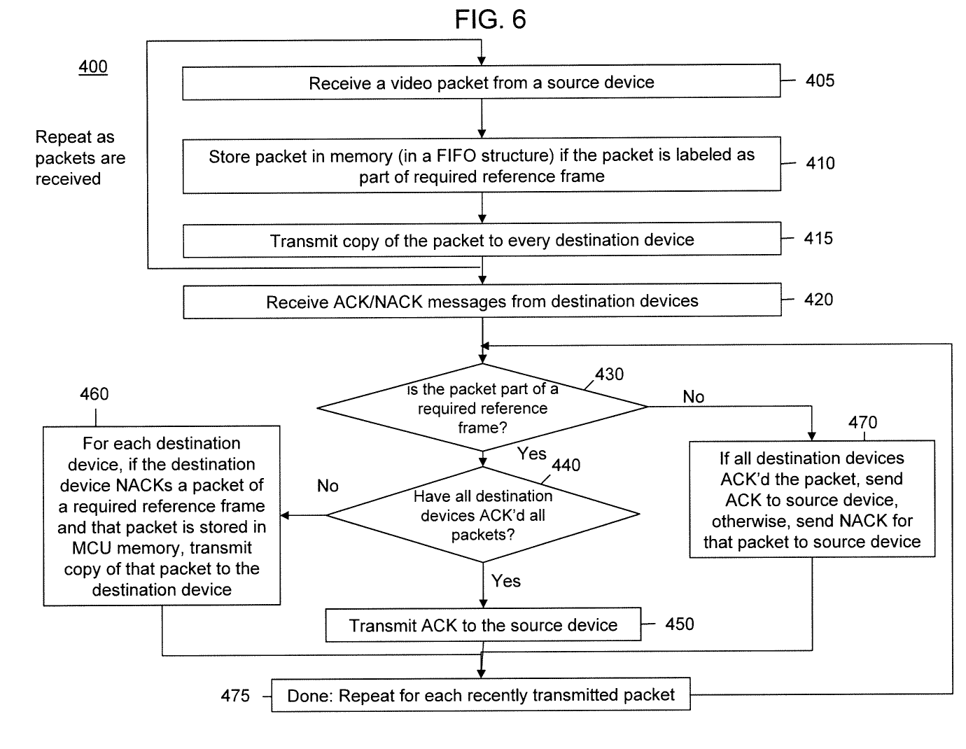

Turning to FIG. 3, a block diagram of the MCU 200 is described. The MCU 200 comprises a network interface and control unit 210 that in turn comprises a processor 212, a memory 214 and a NIC 216. The processor 212 executes instructions stored in the memory 214 for a multipoint control process 400. The memory 214 also stores certain packets that are contained in streams of packets sent from a source endpoint device to a plurality of destination endpoint devices. The multipoint control process 400 is described hereinafter in conjunction with FIG. 6.

The logic for performing the functions of processes 300, 400 and 500 may be embodied by computer software instructions stored or encoded in a computer processor readable memory medium that, when executed by a computer processor, cause the computer processor to perform the process functions described herein. Alternatively, these processes may be embodied in appropriate configured digital logic gates, in programmable or fixed form, such as in an application specific integrated circuit with programmable and/or fixed logic. Thus, in general, these processes may be embodied in fixed or programmable logic, in hardware or computer software form. Furthermore, the functions the encoder 130 and decoder 140 in the endpoint devices may also be performed using logic in a form that is also used for performing the processes 300, 400, and 500.

According to the techniques described herein, certain packets of video are designated or “marked” to be retransmitted if they are lost because these packets are part of valuable reference frames, the aforementioned required reference frames, which will be referenced by many future frames. The fact that these frames are guaranteed to be received correctly at the destination devices is relied upon by the source device of the video stream. Thus, all of the packets associated with a required reference frames should be correctly received by all of the intended destination devices for that video stream.

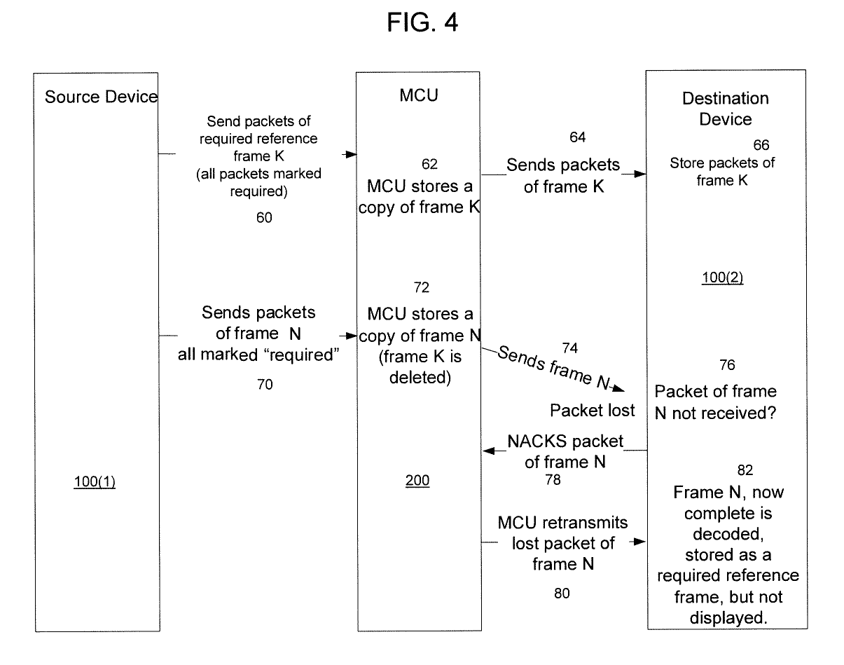

Turning now to FIG. 4, an overview of processes to achieve error resilience by retransmission of packets of certain reference frames is now described, and continues with the example set forth in FIG. 1. When an intended destination device fails to receive and decode a packet that is designated or marked as being associated with a required reference frame, the lost or missing packet is retransmitted to that destination device. The destination device decodes the retransmitted packet even it is associated with a frame that has already been decoded (and displayed) with errors.

Thus, at 60, a source device, e.g., 100(1), sends packets of a required reference frame K to the MCU 50 for distribution to all of the intended destination devices. In this example, one destination device 100(2) is shown. At 62, the MCU stores a copy of the packets for frame K, and at 64 transmits the packets of frame K to all of the intended destination devices, including device 100(2). At 66, device 100(2) receives all of the packets of frame K without error, decodes frame K for storage and uses frame K for displaying data at the appropriate time. Since frame K is complete at all of the destination devices at this point, the source device 100(1) knows that it can, in the future, send repair frames that use frame K at any and all of the destination devices.

At 70, source device 100(2) again sends packets of a new required reference frame, this time called reference frame N. At 72, the MCU stores a copy of the packets for frame N and because frame N is a new required reference frame, the MCU also deletes a copy of the previously received required reference frame, frame K. At 74, the MCU sends the packets for frame N to all of the intended destination devices. At 76, the destination device 100(2) fails to receive without error (i.e., loses) a packet of frame N, and accordingly at 78 sends NACK message to the MCU for the lost packet of frame N. Nevertheless, the destination device 100(2) uses frame N to display a picture at the appropriate time, albeit with the packet error. At 80, the MCU retransmits the lost packet of frame N to destination device 100(2). At 82, the destination device 100(2) receives the lost packet and now has a complete frame N that it decodes and stores as a required reference frame. When the retransmitted packet of frame N is received, it is decoded and stored in memory and is not used for displaying a picture (since the time has passed when it would have been used for displaying a picture). Thus, the required reference frame N has value even if it is not completely available (error-free) at the destination device, due to a lost packet, until after the time at which the picture data in the frame is to be displayed.

As described above, the required reference frame contains picture data associated with a “live” video stream and is therefore intended to be used for generating a picture at the appropriate time when received and decoded by a destination device. In this case, if a required reference frame packet is lost and needs to be retransmitted, the retransmitted packet is not intended for use in displaying picture data at the time that it is received and decoded by the destination device.

According to one variation, the required reference frame may itself be a repair frame. In this case it would not use the previous frame for prediction, and would not propagate any errors in the image from previous frames. A repair frame may be an intra-coded frame (I-frame) described hereinafter. A repair frame may also be a P frame that is motion predicted with reference to a prior (older) reference frame that has been acknowledged by all of the destination devices.

According to another variation, the required reference frame may contain data that is not part of a live-encoded video stream and as such is not intended for use in displaying a picture when it is received (from an initial transmission).

The processes performed at the source device, destination device and MCU are now described in greater detail with reference to FIGS. 5-7.

FIG. 5 illustrates the transmit-side control process 300 that is performed by an endpoint device 100(i) when is acting as a source of video for transmission to a plurality of destination devices (e.g., two or more of endpoint devices 100(2)-100(N) shown in FIG. 1). An endpoint device performs the process 300 any time it is acting as a source device for a video stream. The process shown is executed when a new frame is to be generated. At 310, a determination is made as to whether the new frame is to be a required reference frame. Since a required reference frame is generated to enable repair of a certain number of future frames to be transmitted, it is necessary to generate and encode packets for a new required reference frame after a certain period of time that depends on the nature of the video stream, the packet error rate of the network, etc. The repair frame is predictively encoded with reference to a required reference frame and without reference to a most recent video frame. When it is time to generate a new required reference frame, then at 320, the encoder in the source device encodes the packets for the new required reference frame, marks those packets as being part of a required reference frame, and couples those packets to the NIC in the source device for transmission to the MCU 200. When generating a new required reference frame, the source device may encode the packets for the new required reference frame based solely on one or more previously transmitted required reference frames (such as the most recent required reference frame) that have been successfully decoded and stored by the destination devices. If it is not time to generate a new required reference frame, then at 330 packets for a normal (non-required) new video frame are encoded and transmitted to the MCU 200.

At 340, the source device receives ACK and NACK messages from the destination for packets of past frames that it transmitted, both for a normal video frame transmitted at 330 and for a required reference frame transmitted at 320. As explained hereinafter in conjunction with FIG. 6, the MCU 200 may transmit the ACK and NACK messages for the transmitted packets to the source device based on ACK and NACK messages the MCU 200 receives from the destination devices. Since there is a round-trip delay between the time that the packets are sent and when the ACK/NACKs are received, the ACK/NACKs are associated with packets of frames that were transmitted 10 to 20 frame times ago, for example. Thus, within one second the source device has error feedback on every packet of every frame that it has generated, in this example.

At 350, the source device determines whether all of the destination devices correctly received and decoded (ACK'd) all packets of a previous required frame transmitted at 320. When it is determined that all of the destination devices ACK'd all of the packets of the required reference frame, then at 360, the source device “promotes” the required reference frame, by designating that the required reference frame is a best required reference frame for use in error correction when generating repair frames. In addition, the source device deletes the older required reference frame that was previously transmitted. When at 350 it is determined that one or more destination devices did not receive all the required reference frame packets, no more action is taken on that frame and the process continues to 370. Eventually, the required reference frame will become promoted, since the MCU 200 will take care of retransmitting it until it is completely received by all destination devices. The test 350 will be repeated on each trip through the process 300, at every frame time, so that the source device knows when to promote the frame to be the new best required reference frame.

Next, at 370, based on the ACK and NACK messages received at 340, the source device determines whether any recent frame was received in error. An error in a frame is caused by any lost packet from that frame. If a recent frame was received in error or (a packet is) lost by a destination device, then at 380, the source device generates a repair frame using the most recent best required reference frame as the reference picture and transmits that repair frame to the MCU 200 that sends it to the requesting destination device. As explained above, the repair frame is predictively encoded with reference to the required reference frame and without reference to a most recent video frame. The process 300 then repeats at 310 after 380 or after 370 if it is determined that no recent was received in error or lost by a destination device.

Turning now to FIG. 6, the MCU control process 400 is described. At 405, the MCU receives a video packet from the source device. At 410, the MCU stores the packet in memory if the packet is marked as part of a required reference frame. At 415, the MCU transmits a copy of the packet received at 405 to every destination device. At 420, the MCU receives ACK and NACK messages from destination devices that failed to receive (or correctly decode) a packet transmitted by the MCU. While the MCU is receiving ACK and NACK messages from destination devices, it is also transmitting further video packets and the destination devices continue to decode these video packets. That is, the functions of receiving and transmitting video packets at 405-415 may continue asynchronously with respect to the receiving and processing of ACK/NACKs sent by destination devices.

When a new ACK or NACK is received, the process continues with ACK/NACK processing at 430. It proceeds in a loop as shown by arrow from function 475 back to 430, repeating the next steps for each recently transmitted packet. At 430, the MCU determines for each recently transmitted packet, whether the packet is part of a required reference frame.

If a packet is determined to be part of a required reference frame, then at 440, the MCU determines whether all destination devices have sent an ACK message for a required reference frame packet. At 450, the MCU transmits an ACK to the source device when all destination devices ACK a packet for a required reference frame. When at 440 the MCU determines that all destination devices did not ACK a packet for a required reference frame, then at 460, the MCU determines, for each destination device that did not ACK that packet (i.e. NACK'd a required reference frame packet), whether that packet is stored in MCU memory and if so, the MCU transmits a copy of that packet to the appropriate destination device(s). When that copy packet is ACK'd or NACK'd, the function of 440 will evaluate again whether all devices have ACK'd it. Eventually the packet is received, and the function of 440 evaluates to “yes” and proceeds to 450. The source device is waiting for a confirmation that all of the destination devices have received all packets of the required reference frame as indicated at function 350 of the process 300 shown in the flowchart of FIG. 5.

When at 430 it is determined that the packet is not a required reference frame packet, then at 470, the MCU determines if all destination devices ACK'd the packet and if so, sends an ACK to the source device, and otherwise sends a NACK with a packet sequence identifier for that packet to the source device. The source device uses information contained in the NACK message to generate a repair frame (at 380 in FIG. 5) as described above.

Turning now to FIG. 7, the receive-side control process 500 in an endpoint device is now described. This process is performed in an endpoint device anytime the endpoint device is receiving video packets, and thereby acting as a destination endpoint device. At 510, the endpoint device receives a video packet. At 520, it is determined whether the packet is for a future video frame not yet displayed. The purpose of the function at 520 is to sort out a packet that is retransmitted and thus has arrived at a time after which it would have been used for displaying a picture, as is the case with a retransmitted required reference frame packet. Each packet has a packet sequence number and if the packet sequence number is beyond the packet sequence number at which the destination device is currently displaying a picture, then the packet is not for a video frame or picture not yet displayed. If it is determined at 520 that the packet is for a future video frame not yet displayed, then at 530, the video packet is decoded. At 530, the video packet that is decoded may be a required reference frame packet and if so it is decoded and stored into the reference frame storage portion 158 of the memory 156 in an endpoint device. At 540, at the appropriate or right display time, a video frame is displayed with the packet. Again, the first time packets of a required reference frame are received at the destination device, they may be associated with data for a picture to be displayed and therefore are used in displaying a picture at the appropriate time. After the function at 540, the process 500 proceeds to 570 described hereinafter.

When at 520 it is determined that the packet is not for a future video frame not yet displayed, then the process proceeds to 550 where it is determined whether the packet is part of a required reference frame 550. This would be the case when the device receives a retransmitted required reference frame packet. When the packet is part of a required reference frame, then at 560 the packet is decoded and used to change or update pixel data associated with the previously decoded and stored packets of a required reference frame stored in the required reference frame memory storage 158 of the memory 154. Thus, even though a retransmitted packet for a required reference frame is received too late to be used in generating a picture, the packet is used to update or change picture data in the reference frame storage 158, and the required reference frame is available for later use for a frame repair at a later time. As explained above, when generating a new required reference frame, the source device may encode the packets for the new required reference frame based solely on one or more previously transmitted required reference frames (such as the most recent reference frame) that have been successfully decoded and stored by the destination devices. This reduces complexity in the system because the reference frame needed for image reconstruction is guaranteed to be in memory and it is guaranteed to have been received and decoded without error.

Next, at 570, the endpoint device transmits an ACK message to the MCU for the packet. Then, at 580, the device examines the packet sequence number for the packet to determine whether it indicates that a prior packet (based on that prior packet's packet sequence number) has been lost, and if so at 590 the device transmits a NACK to the source (via the MCU) together with an packet number/identifier for the lost prior packet. The transmitted message at 590 may be referred to as a packet loss message. After that, the process repeats at 510. The NACK message will identify a lost required reference frame packet by packet sequence number and the MCU will respond to this NACK message by retransmitting that required reference frame packet (see functions 440 and 460 in FIG. 6). Otherwise, if the packet sequence number does not indicate that a prior packet has been lost, the process repeats at 510.

It is evident from the description of the process 500 that a device decodes a received repair frame and displays a picture from the repair frame, wherein the repair frame is predictively encoded with reference to the required reference frame and without reference to a most recent video frame.

While the foregoing description and figures indicate that the MCU serves as an intermediary between endpoint devices, it should be understood that the MCU is not required. That is, there may be circumstances or implementations in which each endpoint device also performs the MCU functions depicted in FIG. 7 such that endpoint devices communicate directly with each other.

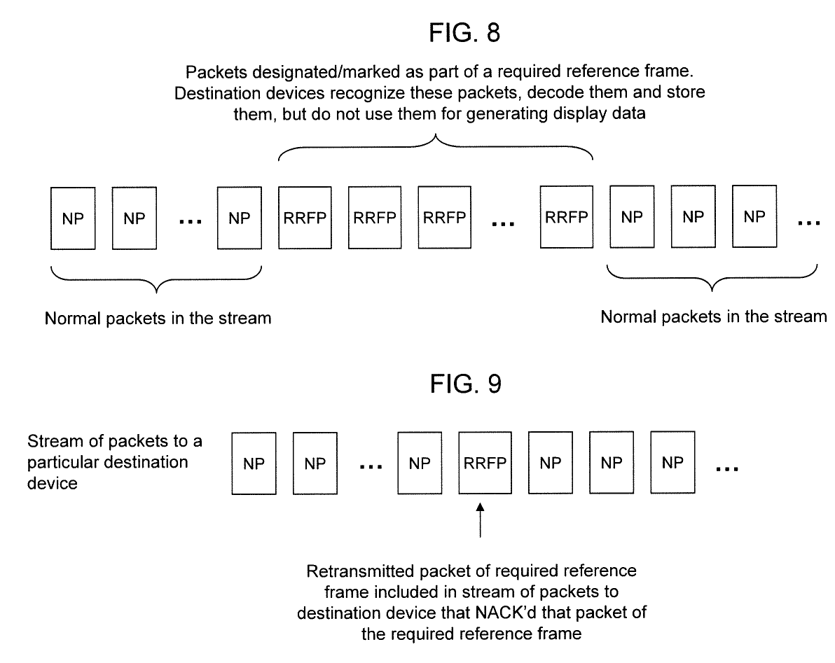

FIG. 8 illustrates a timing diagram that shows how required reference frame packets (RRFPs) may be transmitted in a stream of video packets that also contains normal video packets (NPs). An endpoint device generates a continuous stream of video packets based on video data produced by its associated video camera(s). As this stream is being generated, the device will include a plurality of RRFPs in the stream in order to communicate a new required reference frame to the destination devices for purposes of enabling more efficient repair in the event a destination device fails to receive one or more NPs at some point in time in the future after the RRFPs have been transmitted and successfully decoded and store at the destination devices. The stream of packets shown in FIG. 8 is an example of a stream that would be transmitted to all of the destination devices. As explained above, the RRFPs, like the NPs, may contain “live” video picture information such that when received by the endpoint device, they are decoded and used for displaying a picture at the appropriate time, or they may contain “canned” video that is not part of a “live” video picture stream for prompt display. In either case, the RRFPs are encoded to include data used for repair purposes using prediction encoding techniques. Endpoint devices may be configured to transmit packets (for the initial transmission) using a protocol, such as the real-time transport (RTP) protocol, which is a protocol that does not have a built-in error feedback retransmission feature.

FIG. 9 illustrates a stream of packets that is sent to a particular destination device. In this regard, when a particular destination device fails to successfully receive and decode an RRFP, the destination device sends a NACK and the MCU (or the source device) retransmits that RRFP only to that particular destination device. Thus, the stream in FIG. 9 shows that there is a plurality of NPs transmitted to the particular destination device and at some point in this stream, the retransmitted RRFP is included. The retransmitted RRFP is included in the stream with NPs that are intended to be decoded and displayed promptly after their reception by the destination device. This is not the case for the retransmitted RFFP because it will be received later than its originally intended display time, but it is nevertheless decoded and used to correct/update the associated required reference frame for which the remaining packets have already been received and decoded at the destination device. Thus, the NPs in the stream shown in FIG. 9 are decoded and used for display at the appropriate time promptly after they are received, whereas the RFFP received in the stream shown in FIG. 9 is decoded and used to update the associated reference frame which is stored, but the RFFP is not used to generate a picture at any time promptly after it is received unless and until a repair frame is transmitted that points to the reference frame to repair a subsequently transmitted frame that has errors or otherwise requires a repair. The MCU may be configured to retransmit lost packets to a destination device using a protocol such as the transmission control protocol (TCP).

As is known in the art, a group of pictures (GOP) sequence formatted according to the MPEG standards begins with an intra-coded (I) picture or frame that serves as an anchor. All of the frames after an I frame are part of a GOP sequence. Within the GOP sequence there are a number of forward predicted or P frames. The first P frame is decoded using the I frame as a reference using motion compensation and adding difference data. The next and subsequent P frames are decoded using the previous P frame as a reference. When a new endpoint joins a communication session, it will need to receive an I-frame to begin decoding the stream, but thereafter it may not need to receive another I-frame if the techniques described herein for a required reference frame are used. In fact, the I-frame may be encoded so as to serve as both an I-frame and as a required reference frame.

There are numerous advantages of the scheme described above and depicted in FIGS. 1 and 4-7. First, because this mechanism ensures that all destination devices receive a required reference frame, the use of such a reference frame-based repair mechanism is more viable with there are a large number of endpoint devices involved (i.e., a large number of destination devices). Moreover, the reference frame-based repair technique can be used over networks that exhibit greater packet loss performance because, again, certain reference frames are designated as required reference frames whose error free reception is in essence guaranteed by the retransmission techniques described herein. Further, the source device avoids a situation where it has to send numerous I-frames to repair past errors experienced by a destination device. Instead, the source device can use more predictive coding and therefore provide higher quality video to the destination devices. The delivery mechanism described herein provides for retransmission of packets of a required reference frame based on packet loss, rather than using additional bandwidth to add redundancy for required reference frames.

The required reference frame packet retransmission techniques described herein achieves improved picture quality even when the network is introducing packet loss issues. Prior retransmission schemes cause delays. Forward error correction (FEC) increases payload size unconditionally. FEC also causes latency when data is redistributed over multiple packets.

The techniques described herein provide some of the quality improvement of retransmission, but without an increase in the video latency. The techniques described herein guarantee that a certain reference frame is ultimately received and decoded without error by all intended destination devices. If a retransmission is necessary to achieve this, it is only a retransmission of one or packets that were lost or not decodable. Furthermore, the retransmission occurs only between the MCU and the destination endpoint device that experiences the lost packet. Consequently, a greater number of endpoint destination devices can be accommodated without bogging down the source endpoint device.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

What is claimed is:

1. A method comprising:
designating a plurality of video packets as being part of a required reference frame that is subsequently to be used for a repair process;
transmitting a stream of video packets that includes the packets for the required reference frame from a source device over a communication medium for reception by a plurality of destination devices;
determining that at least one of the plurality of destination devices did not receive at least one packet of the required reference frame; and
in response to said determining, retransmitting the at least one packet of the required reference frame to the at least one of the plurality of destination devices.

2. The method of claim 1, and further comprising receiving and decoding at the at least one destination device the at least one packet that is retransmitted, updating data for the required reference frame using the at least one packet and storing the required reference frame.

3. The method of claim 2, and further comprising at the at least one destination device, receiving, decoding and storing the at least one packet that is retransmitted without using the at least one packet for generating a picture for display at the time that the at least one packet is received.

4. The method of claim 1, wherein said retransmitting is performed in response to packet loss messages received from multiple destination devices until all of the plurality of destination devices have successfully received and decoded all packets of the required reference frame.

5. The method of claim 4, and further comprising generating one or more repair frames that refers to the required reference frame, and transmitting the one or more repair frames to a particular destination device in response to receiving a packet loss message from the particular destination device.

6. The method of claim 5, wherein said generating comprises generating the one or more repair frames using predictive coding.

7. The method of claim 4, wherein in response to determining that all of the plurality of destination devices have received all packets of the required reference frame, further comprising designating the required reference frame as a best required reference frame for use in generating repair frames.

8. The method of claim 1, wherein said designating is performed at the source device, and wherein said transmitting comprises first transmitting the plurality of video packets to an intermediary device, storing the plurality of packets at the intermediate device, and second transmitting the plurality of packets from the intermediary device to the plurality of destination devices.

9. The method of claim 8, wherein said determining and retransmitting are performed at the intermediary device.

10. The method of claim 1, and further comprising encoding a new required reference frame by motion prediction referring to a prior required reference frame that was previously transmitted to the plurality of destination devices.

11. A method comprising:
receiving a stream of video packets that includes packets which are designated as being part of a required reference frame that is subsequently to be used for a repair process; and
decoding and storing the video packets;
determining that at least one of the packets that is designated as being part of the required reference frame has been lost;
receiving a retransmission of the at least one packet; and
decoding the at least one packet without using the at least one packet for generating a picture for display at the time that the at least one packet is received.

12. The method of claim 11, and further comprising updating data for the required reference frame using the at least one packet that is retransmitted, and storing the required reference frame for later use.

13. The method of claim 12, and further comprising decoding a received repair frame and displays picture from the received repair frame that is predictively encoded with reference to the required reference frame and without reference to a most video recent frame.

14. An apparatus comprising:
a decoder that is configured to decode video packets in order to produce pictures for display;
a network interface unit coupled to the decoder that is configured to receive a stream of video packets via a network that was transmitted by a source device connected to the network;
a controller coupled to the decoder and the network interface unit, wherein the controller is configured to:
determine that packets contained in received stream of video packets are designated as being part of a required reference frame that is subsequently to be used for a repair process;
determine that at least one of the packets that is designated as being part of the required reference frame has been lost;
causing the decoder to decode a received retransmission of the at least one packet without using the at least one packet for generating a picture for display at the time that a retransmission of the at least one packet is received.

15. The apparatus of claim 14, wherein the controller is further configured to update data for the required reference frame using the received retransmission of the at least one packet, and storing the required reference frame for later use.

16. The apparatus of claim 15, wherein said is configured to decode a repair frame and display a picture from the repair frame that is predictively encoded with reference to the required reference frame and without reference to a most recent video frame.

17. Logic encoded in one or more tangible media for execution and when executed operable to:
determine that packets contained in a received stream of video packets are designated as being part of a required reference frame that is subsequently to be used for a repair process;
determine that at least one of the packets that is designated as being part of the required reference frame has been lost or cannot be decoded;
decoding a received retransmission of the at least one packet without using the at least one packet for generating a picture for display at the time that a retransmission of the at least one packet is received.

18. The logic of claim 17, and further comprising logic that updates data for the required reference frame using the received retransmission of the at least one packet, and logic that stores the required reference frame for later use.

19. The logic of claim 17, and further comprising logic that decodes a repair frame and displays a picture from the repair frame that is predictively encoded with reference to the required reference frame and without reference to a most recent video frame.
